(19) United States
(12) Patent Application Publication
(10) Pub. No.: US 2023/0237336 A1
(43) Pub. Date: Jul. 27, 2023

(54) Self-Pruning Neural Networks with Regularized Auxiliary Variables

(71) Applicant: Oracle International Corporation, Redwood City, CA (US)

(72) Inventor: Daniel Wyde Peterson, Laramie, WY (US)

(21) Appl. No.: 18/157,755

(22) Filed: Jan. 20, 2023

Related U.S. Application Data
(60) Provisional application No. 63/303,437, filed on Jan. 26, 2022.

(51) Int. Cl. G06N 3/082; G06N 3/084

(52) U.S. Cl. CPC G06N 3/082; G06N 3/084

(57) ABSTRACT

Methods, techniques and systems for providing self-pruning neural networks are disclosed. A neural network including a plurality of layers may be trained using a batch sampled from a dataset. In addition to simulated neurons, individual ones of the plurality of layers include respective auxiliary parameters that may identify relative contributions of respective layers to the accuracy of the trained model. The respective layers of the neural network may be trained using a training batch to determine a penalty according to a regularization penalty for the neural network, the penalty determined according to a number of layers in the neural network. Prior to completion of the training batch and in accordance with the regularization penalty, one or more neurons of the neural network may be identified and deleted using the respective auxiliary parameters, thus providing a self-pruning mechanism to control growth and resource demands for the neural network.

### BACKGROUND

This application claims benefit of priority to U.S. Provisional Application Ser. No. 63/303,437, entitled “Self-Pruning Neural Networks with Regularized Auxiliary Variables,” filed Jan. 26, 2022, and which is hereby incorporated herein by reference in its entirety.

### FIELD OF THE DISCLOSURE

This disclosure relates to an improved method for training machine learning models to improve performance and accuracy.

### DESCRIPTION OF THE RELATED ART

Deep learning frameworks have transformed machine learning in many ways and, in general, the state-of-the-art model for any given task is a large, over-parameterized neural network. These are costly to train and deploy, and practical considerations (hardware constraints, time to compute in inference) are often pushed to the limit in the service of higher prediction accuracy. Getting deep learning models to work often requires skill and experience: training a high-quality network means using a many varied explicit and implicit regularizers to help the model generalize. In the class of regularizers, L0 regularization (constraining the number of parameters) has a special place: it is well-motivated theoretically but difficult to achieve in practice. Empirically, models with more parameters generalize better.

### SUMMARY

Methods, techniques and systems are described for providing self-pruning neural networks. A neural network including a plurality of layers may be trained using a batch sampled from a dataset. In addition to simulated neurons, individual ones of the plurality of layers include respective auxiliary parameters that may identify relative contributions of respective layers to the accuracy of the trained model. The respective layers of the neural network may be trained using a training batch to determine a penalty according to a regularization penalty for the neural network, the penalty determined according to a number of layers in the neural network. Prior to completion of the training batch and in accordance with the regularization penalty, one or more neurons of the neural network may be identified and deleted using the respective auxiliary parameters, thus providing a self-pruning mechanism to control growth and resource demands for the neural network.

### BRIEF DESCRIPTION OF THE DRAWINGS

FIG. 1 is a block diagram illustrating a system implementing a self-pruning neural network, according to various embodiments.

FIG. 2A is a block diagram illustrating a neuron of a neural network, in various embodiments.

FIG. 2B is a block diagram illustrating a gated neuron of a neural network, in various embodiments.

FIG. 3 is a block diagram illustrating training iterations of a self-pruning neural network, in various embodiments.

FIG. 4 is a flow diagram illustrating an embodiment training of a self-pruning network, in some embodiments.

FIG. 5 is a block diagram illustrating one embodiment of a computing system that is configured to implement position-independent addressing modes, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Deep learning frameworks have transformed machine learning in many ways, and in general the state-of-the-art model for any given task is a large, over-parameterized neural network. Such networks are costly to train and deploy, and practical considerations, hardware constraints, time to compute inferences, etc. often constrain performance and prediction accuracy. Furthermore, training effective deep learning models often requires skill and experience: training a high-quality network means using an assortment of varied explicit and implicit regularizers to help the model generalize. In the class of regularizers, LO regularization (constraining the number of parameters) has a special place: it is well-motivated theoretically but difficult to achieve in practice. Empirically, models with more parameters generalize better, even if only because they contain a sub-network that can learn to perform the task well.

The problem of pruning unnecessary parameters from neural networks is well-studied as there have always been strong reasons to eliminate unnecessary variables from a trained model. Various schemes for dropping weights have been proposed, tested, and put into practice. Disclosed herein are various embodiments of a self-pruning neural network. In some embodiments, entire neurons may be dropped from the network during pruning. Dropping a single neuron in an intermediate layer allows for removal of an entire column from a weights matrix of the previous layer, and an entire row in a layer following it. This result in the multiplying of smaller matrices, performing smaller numbers of computations and elimination of special handling for sparse matrices.

In some embodiments, training of network weights occurs simultaneously with the pruning scheme; since the network prunes on the fly, large networks are not trained to convergence and full retraining may be avoided.

In some embodiments, the pruning scheme adds auxiliary parameters which function as soft gates. One auxiliary parameter may be added per neuron, in some embodiments, and once training has converged, or a desired level of sparsity is achieved, these auxiliary parameters may be rolled into the weight matrices. In this way, the embodiments effectively re-parameterize the standard weight matrices. This reparameterization may allow for achieving L0 regularization on the neurons while converting back to a standard parameterization for inference, allowing for later computational efficiency.

Thus, various embodiments may employ a simple, single-pass L0 regularization scheme using auxiliary parameters that function as gates on the neurons. This allows for hard pruning of unnecessary neurons during training. The resulting sparsity may reduce the number of network parameters dramatically during training while still producing high-quality models.

A canonical neural network may be composed of L layers of artificial neurons.

Each neuron may implement a function of input weights and a linear transformation followed by a nonlinear activation function. Together, the neurons in layer 1∈1;:::; L transform the outputs of the previous layer using:

aᵢ= [symbol] (Wa₁₋₁+b)

where a₁ are the activations of layer 1, is a nonlinear function such as a

Rectified Linear Unit function (ReLU) or a sigmoid function, W is a weight matrix, and b is a bias vector. If layer 1 has n inputs and m neurons, W∈Rn×m and b∈Rm. In this notation, a₀ are the network inputs. This network may be trained using stochastic gradient descent to minimize a loss function:

L(X; Y|θ)=(1/N)ΣᵢL(xᵢ; yᵢ|θ)

across a data set X={x1;:::; xN}, Y={y1;:::; yN}, and network parameters θ={W1;:::; WL; b1;:::; bl}.

To reduce the number of network parameters in a manner that allows efficient computation, a penalty may be introduced to the model that penalizes the overall number of inputs (roughly, the number of neurons) used cumulatively across all layers:

L(X, Y|θ)=Σ_{i∈1, . . . , N}L(xᵢ, yᵢ|θ)+Σ_{1∈1, . . . , L}∥a₁∥0

where ∥.∥0 is the L₀ norm.

Rather than applying an L0 regularization term to the weight matrices, the number of neurons may instead be regularized. Dropping a single neuron has a dramatic impact on the number of total network parameters because it removes entire rows and columns from the weight matrices. However, the regularization term is not differentiable so is not straightforward to train using stochastic gradient descent. To address this, auxiliary parameters, s, may be employed to derive gating magnitudes, g=min(1; max(0; g)). In layer 1, the inputs may be multiplied by the values of the gates before passing to the weight matrices:

a₁= [symbol] (W(a₁₋₁⊙g₁)+b)

Here, ⊙ is the Hadamard product. A regularization term may then be introduced into the loss function which penalizes the total magnitude of auxiliary parameters in the network, but is differentiable:

L(X, Y|θ)=Σ_{i∈1, . . . , N}L(xᵢ, yᵢ|θ)+λΣ_{1∈1, . . . , L}∥s₁∥₁

During training, the auxiliary parameters s may be constrained to lie in a feasible range close to the allowable range of the gating parameters g, s∈|−ϵ, 1+ϵ|. As the auxiliary parameters s are passed through a hard gate, rather than a sigmoid, inputs from the layer may be completely eliminated. The auxiliary parameters are trained along with the weight matrices using minibatch stochastic gradient descent and the Adam optimizer.

In order to speed training, neurons may be discarded that have been set to zero, re-instantiating a new network with smaller weight matrices. This provides the advantage that later epochs are running a smaller and faster network.

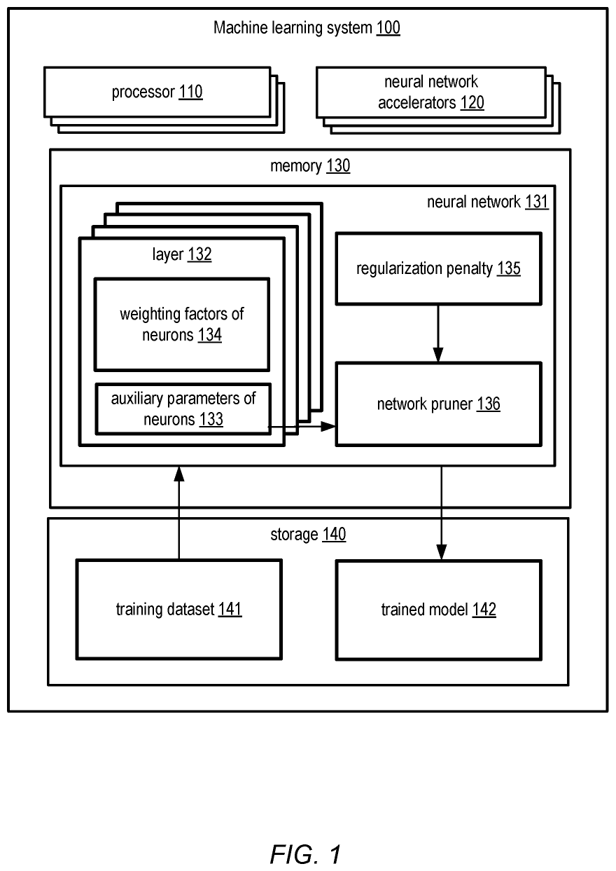

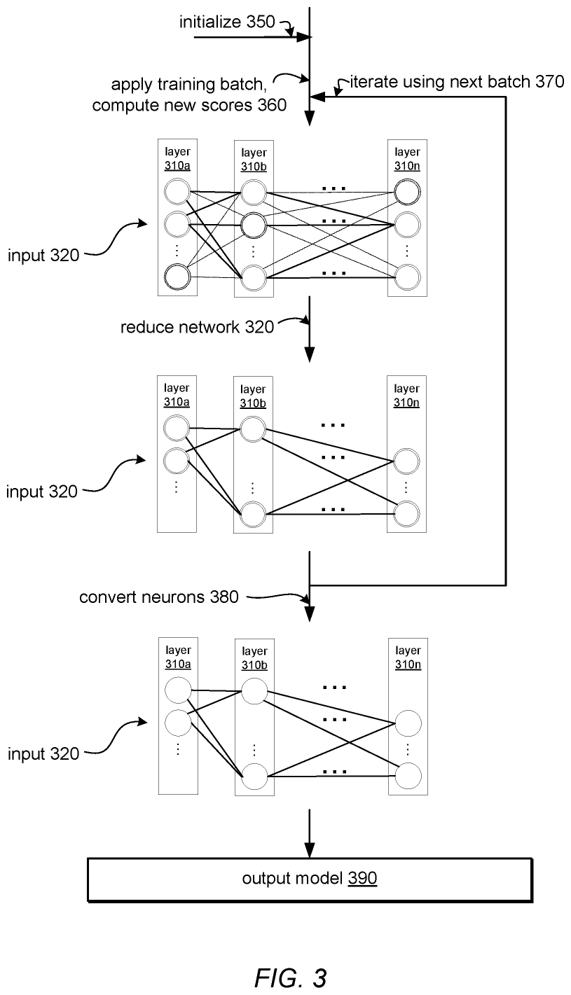

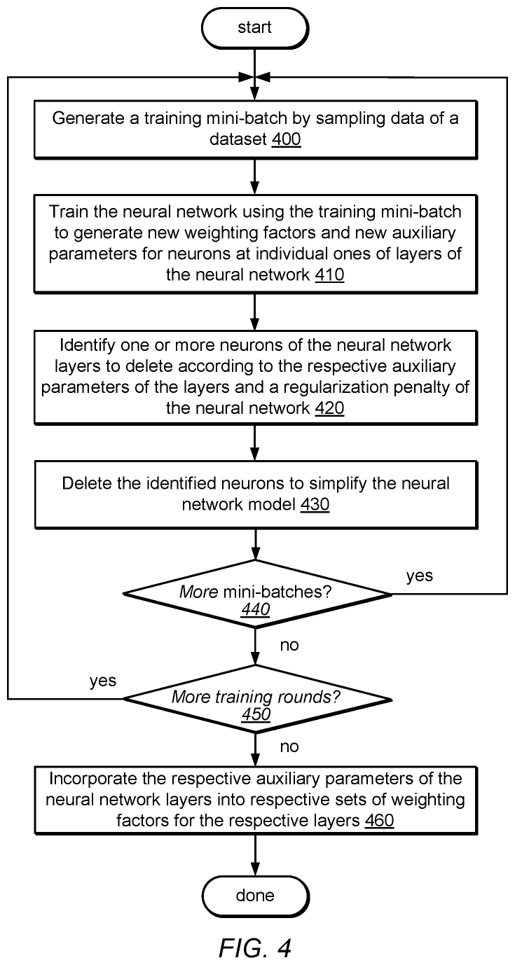

FIG. 1 is a block diagram illustrating a system implementing a self-pruning neural network, according to various embodiments. A machine learning system 100 may be implemented using one or more computing nodes such as those discussed in greater below with regard to FIGS. 3 and 4. The machine learning system 100 may include one or more processors 110 and memory 130 and optionally include one or more neural network accelerators 120

Contained with the memory 130 of the machine learning system 100 is all or part of a neural network 131. The neural network 131 may receive training dataset(s) 141 to generate trained models 142 for the machine learning system 100. These training dataset(s) 141 and trained model(s) 142 may be store in storage 140 which be locally attached to the computer node(s) implementing the machine learning system 100 or be stored remotely on network-attached storage or as part of cloud storage provided by a service provider network that may provide machine learning services that incorporate the machine learning system 100.

The neural network 131 may include multiple neural network layers 132. Each of these layers includes a set of weighting factors, or weighting vectors or weighting matrices of neurons, 134 and additionally includes an auxiliary parameters of neurons 133. These auxiliary parameters may function as soft gates. One auxiliary parameter may be added per neuron, in some embodiments, and once training has converged, or a desired level of sparsity is achieved, the auxiliary parameters may be rolled into the weight matrices. In this way, various embodiments effectively re-parameterize the standard weighting matrices. This process is discussed in further detail in FIG. 3 below.

The neural network 131 may further include a network pruner 136 that implements self-pruning of the neural network during training. During individual training minibatches, the network pruner 136 may access the respective auxiliary parameters of neurons 133 of the various layers 132 and, in consideration of a regularization penalty 135 for the neural network, identify one or more of the layers 132 to prune. This process is discussed in further detail in FIG. 3 below. The regularization penalty 135 may take into consideration a variety of performance factors for the neural network, including for example training accuracy, training data size and content, and computing and memory resources of the machine learning system 100 in order to enable the network pruner 136 to make appropriate cost/benefit tradeoffs when identifying whether to retain or prune various layers of the model during training. The above examples of performance factors contributing to the regularization penalty 135 are not intended to be limiting and any number of factors may be envisioned.

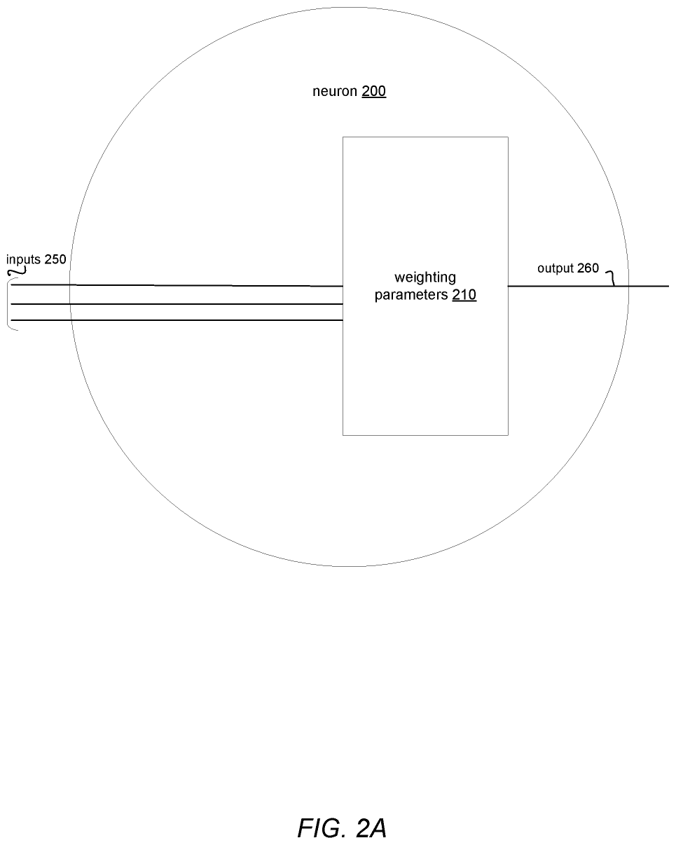

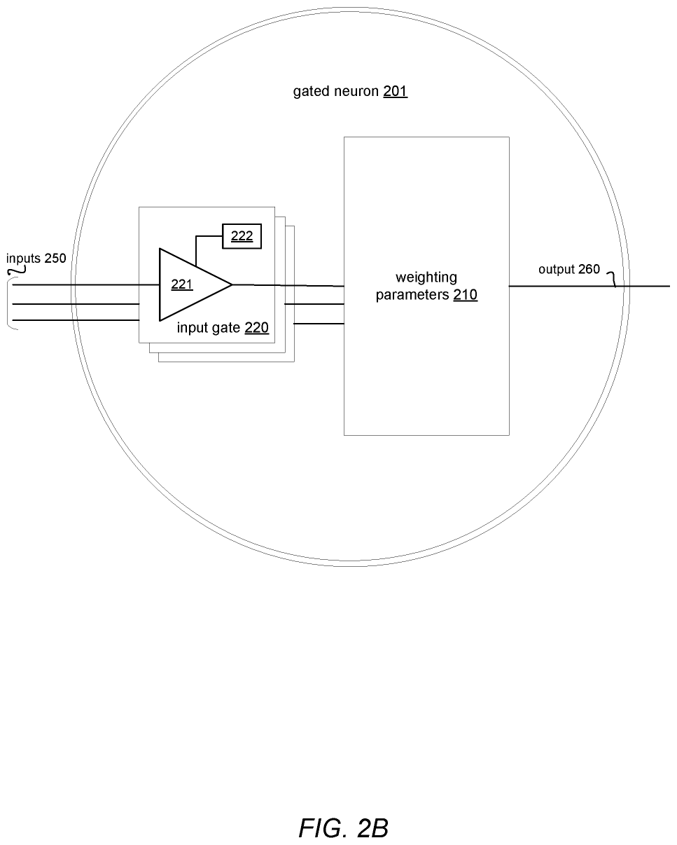

FIG. 2A is a block diagram illustrating a neuron of a neural network, in various embodiments. A neural network, such as the neural network 131 of FIG. 1, may include a number of layers, such as the layers 132 of FIG. 1, in some embodiments. Each layer may include a number of inputs 250, with the first layer of the neural network receiving as input, inputs from a data source and subsequent layers receiving as input the outputs of the immediately preceding layer. Individual layers include a number of neurons 200, which may include a set of weighting factors 210, such as the weighting factors of neurons 134 as shown in FIG. 1. Each neuron receives as input the inputs of its respective layer and generate an output 260, in some embodiments.

The outputs of the collective neurons of a layer for the set of outputs for that layer, with the outputs of the first and intermediate layers serving as inputs to subsequent layers and the outputs of a final layer serving as outputs of the neural network.

FIG. 2B is a block diagram illustrating a gated neuron of a neural network, in various embodiments. A neural network, such as the neural network 131 of FIG. 1, may include a number of layers, such as the layers 132 of FIG. 1, in some embodiments. Each layer may include a number of inputs 250, with the first layer of the neural network receiving as input, inputs from a data source and subsequent layers receiving as input the outputs of the immediately preceding layer. Individual layers include a number of gated neurons 201, which may include a set of weighting factors 210, such as the weighting factors of neurons 134 as shown in FIG. 1. Each neuron receives as input the inputs of its respective layer and generate an output 260, in some embodiments.

The respective inputs of a gated neuron 201 may first be gated by an input gate 220 before being processed using the set of weighting factors 210. The input gate 220 may either enable or disable the input according to a gating factor at 221. This gating factor may be determined using an auxiliary parameter 222, where the auxiliary parameter 222 may be trained along with the set of weighting parameters 210 using a Stochastic Gradient Descent (SGD) technique. At any time, a gated neuron 210 may be converted to a conventional neuron 200 by incorporating the auxiliary parameter 222 into the set of weighting parameters 210, as shown below in FIGS. 3 and 4. By converting gated neurons to conventional neurons, an output model may be generated using conventional neurons suitable for use with a variety of conventional inference engines, in some embodiments.

The outputs of the collective neurons of a layer for the set of outputs for that layer, with the outputs of the first and intermediate layers serving as inputs to subsequent layers and the outputs of a final layer serving as outputs of the neural network.

FIG. 3 is a block diagram illustrating training iterations of a self-pruning neural network, in various embodiments. A neural network may be initialized 350, where the neural network, such as the neural network 131 of FIG. 1, may include multiple layers 310a-310n each including multiple gated neurons, with respective neurons in consecutive layers be interconnected using weighting factors, in some embodiments. Network layers 310 in FIG. 3 are depicted vertically with individual gated neurons depicted using double circles, such as shown in FIG. 2B. Active interconnections between nodes of the subnetwork are depicted as solid lines while inactive, disabled, or excluded interconnections are shown as dotted lines between nodes.

A given training cycle, batch or mini-batch 360 may be applied to train the network, in some embodiments. Network training may include training respective sets of weighting factors of neurons, such as the weighting factors of neurons 134 as shown in FIG. 1, in the various layers as well as training respective auxiliary parameters, such as the auxiliary parameters of neurons 133, as shown in FIG. 1, in various embodiments. Such training may be performed in different ways, in various embodiments. For example, training may be implemented using a Stochastic Gradient Descent (SGD) technique. This example, however, is not intended to be limiting and other training techniques may be envisioned.

Once network training for a batch or mini-batch is complete, gating factors, such as the gating factors 221 of FIG. 2B, may be determined using respective auxiliary parameters, such as the auxiliary parameters 222 of FIG. 2B, in some embodiments. Neurons whose respective outputs may no longer be used as indicated by respective gating factors, may be eliminated by reducing the network 320. By eliminating whole neurons, matrix operations using the weighting factors of remaining neurons may be significantly simplified.

Once a stable subnetwork is realized, the process may then iterate according to a next training cycle, batch or mini-batch 370. Upon completion of all training cycles, the gated neurons of the various layers 310 may be converted to conventional neurons by incorporating the respective auxiliary parameters of the neurons into the respective sets of weighting parameters of those neurons. After the gated neurons have been converted to conventional neurons, an output model 380 may be provided, in some embodiments.

FIG. 4 is a flow diagram illustrating an embodiment training of a self-pruning network, in some embodiments. The process begins at step 400 where, to train a neural network, a dataset, such as the training dataset 141 as shown in FIG. 1, may be sampled to generate a subset of the dataset, also known as a mini-batch. This mini-batch may then be used to at least partially train a neural network, such as the neural network 131 of FIG. 1, in some embodiments.

The process may then advance to step 410 where the neural network may be trained using the sampled mini-batch, in some embodiments. The result of this training may be alterations to the weighting matrices of various layers of the neural network, such as the weighting factors of neurons of neurons 134 of layers 132 as shown in FIG. 1. Additionally, training may result in alterations to the auxiliary parameters of the various layers, such as the auxiliary parameters of neurons 133 as shown in FIG. 1. Changes to auxiliary parameters as a result of training may identify neurons of the neural network as candidates for pruning to improve efficiency and accuracy of the training process, in some embodiments.

The process may then advance to step 420 where one or more of the neurons within the neural network layers may be identified for deletion to improve performance of the neural network training. This identifying may be performed according to a regularization penalty of the neural network, such as the regularization penalty 135 of FIG. 1. The regularization penalty may take into consideration a variety of performance factors for the neural network, including for example training accuracy, training data size and content, and computing and memory resources of the machine learning system, to make appropriate cost/benefit tradeoffs when identifying whether to retain or prune various neurons of the model during training. The above examples of performance factors contributing to the regularization penalty are not intended to be limiting and any number of factors may be envisioned.

The process may then advance to step 430 where the identified neural network neurons may be deleted, or pruned, to simplify and improve the efficiency of the neural network model.

Then, if more mini-batches are needed for training, as shown in a positive exit from 440, the process may return to step 400 in various embodiments. If all mini-batches are complete, as shown in a negative exist from 440, the process may proceed to step 450.

If more training rounds are needed for training, as shown in a positive exit from 450, the process may return to step 400 in various embodiments. If no more training rounds are needed and training is therefore complete, as shown in a negative exist from 450, the process may proceed to step 460.

As shown in 460, in some embodiments the respective auxiliary parameters of various layers of the neural network model may be incorporated into the weighting matrices of the various layers. Once training has converged, or a desired level of sparsity is achieved, the auxiliary parameters may be incorporated into the weight matrices, thus converting back to a standard parameterization for model inference that provides for improved computational efficiency.

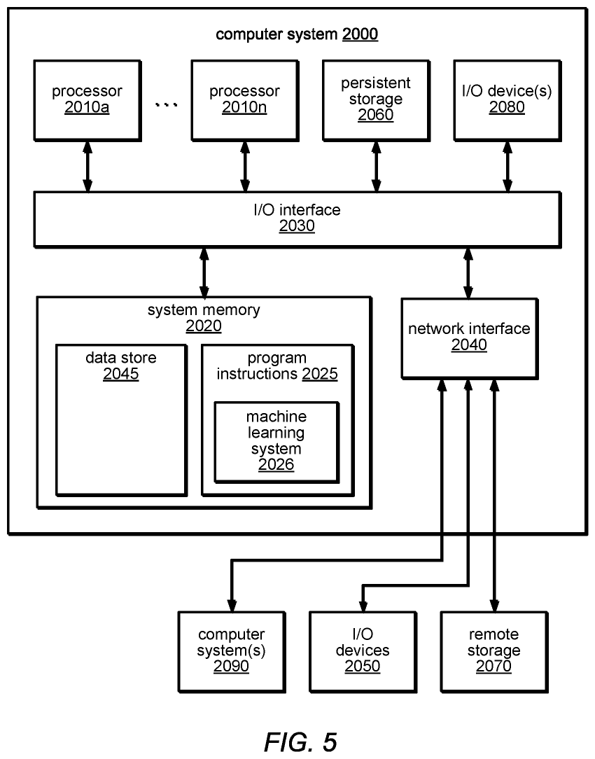

Any of various computer systems may be configured to implement processes associated with a technique for multi-region, multi-primary data store replication as discussed with regard to the various figures above. FIG. 5 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 5 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for a machine learning system as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 5 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A method comprising:
training a neural network comprising a plurality of neuron layers, the training comprising performing, for a training batch of a plurality of training batches:
training respective layers of the plurality of layers according to the training batch, wherein individual ones of the respective layers respectively comprise one or more neurons individually comprising a set of auxiliary parameters and a set of weighting factors, and wherein training individual ones of the respective layers updates the respective sets of auxiliary parameters and the respective sets of weighting factors of the individual ones of the one or more neurons in the respective layers;
identifying one or more neurons for deletion according to the respective sets of auxiliary parameters and a regularization penalty for the neural network; and
deleting the identified one or more neurons from the neural network prior to completion of the training batch.

2. The method of claim 1, further comprising:
integrating, subsequent to completion of training of the plurality of training batches, the respective auxiliary parameters into the respective sets of weighting factors for individual ones of the one or more neurons in the respective layers; and
removing the respective auxiliary parameters from the neural network.

3. The method of claim 1, wherein training a layer of the plurality of layers comprises:
deriving respective gating parameters for inputs to respective neurons of the layer according to the respective sets of auxiliary parameters; and
multiplying the respective gating parameters to the inputs to respective neurons to generate gated inputs to be applied to the respective sets of weighting factors of the neurons.

4. The method of claim 1, wherein training the respective layers of the plurality of layers is performed using a stochastic gradient descent technique.

5. The method of claim 4, wherein the stochastic gradient descent technique employs a loss functions comprising a differentiable regularization term which favors a lesser total number of auxiliary parameters in the network.

6. The method of claim 4, wherein the respective gating parameters are non-stochastic.

7. The method of claim 1, wherein training the respective layers, identifying the one or more neurons for deletion and deleting the identified one or more neurons is performed for more than one of the plurality of training batches.

8. One or more non-transitory computer-accessible storage media storing program instructions that when executed on or across one or more computing devices cause the one or more computing devices to implement:
training respective layers of the plurality of layers according to the training batch, wherein individual ones of the respective layers respectively comprise one or more neurons individually comprising a set of auxiliary parameters and a set of weighting factors, and wherein training individual ones of the respective layers updates the respective sets of auxiliary parameters and the respective sets of weighting factors of the individual ones of the one or more neurons in the respective layers;
identifying one or more neurons for deletion according to the respective sets of auxiliary parameters and a regularization penalty for the neural network; and
deleting the identified one or more neurons from the neural network prior to completion of the training batch.

9. The one or more non-transitory computer-accessible storage media of claim 8, wherein the program instructions, when executed on or across one or more computing devices, cause the one or more computing devices to further implement:
integrating, subsequent to completion of training of the plurality of training batches, the respective auxiliary parameters into the respective sets of weighting factors for individual ones of the one or more neurons in the respective layers; and
removing the respective auxiliary parameters from the neural network.

10. The one or more non-transitory computer-accessible storage media of claim 8, wherein training a layer of the plurality of layers comprises:
deriving respective gating parameters for inputs to respective neurons of the layer according to the respective sets of auxiliary parameters; and
multiplying the respective gating parameters to the inputs to respective neurons to generate gated inputs to be applied to the respective sets of weighting factors of the neurons.

11. The one or more non-transitory computer-accessible storage media of claim 8, wherein training the respective layers of the plurality of layers is performed using a stochastic gradient descent technique.

12. The one or more non-transitory computer-accessible storage media of claim 8, wherein the stochastic gradient descent technique employs a loss functions comprising a differentiable regularization term which favors a lesser total number of auxiliary parameters in the network.

13. The one or more non-transitory computer-accessible storage media of claim 8, wherein the respective gating parameters are non-stochastic.

14. The one or more non-transitory computer-accessible storage media of claim 8, wherein training the respective layers, identifying the one or more neurons for deletion and deleting the identified one or more neurons is performed for more than one of the plurality of training batches.

15. A system, comprising:
one or more processors; and
a memory storing program instructions that when executed by the one or more processors cause the one or more processors to implement a machine learning system configured to train a neural network comprising a plurality of neuron layers, wherein to train the neural network the machine learning system is configured to perform, for a training batch of a plurality of training batches:
train respective layers of the plurality of layers according to the training batch, wherein individual ones of the respective layers respectively comprise one or more neurons individually comprising a set of auxiliary parameters and a set of weighting factors, and wherein training individual ones of the respective layers updates the respective sets of auxiliary parameters and the respective sets of weighting factors of the individual ones of the one or more neurons in the respective layers;
identify one or more neurons for deletion according to the respective sets of auxiliary parameters and a regularization penalty for the neural network; and
delete the identified one or more neurons from the neural network prior to completion of the training batch.

16. The system of claim 15, wherein to train the neural network the machine learning system is further configured to:
integrate, subsequent to completion of training of the plurality of training batches, the respective auxiliary parameters into the respective sets of weighting factors for individual ones of the one or more neurons in the respective layers; and
remove the respective auxiliary parameters from the neural network.

17. The system of claim 15, wherein to train a layer of the plurality of layers the machine learning system is further configured to:
derive respective gating parameters for inputs to respective neurons of the layer according to the respective sets of auxiliary parameters; and
multiply the respective gating parameters to the inputs to respective neurons to generate gated inputs to be applied to the respective sets of weighting factors of the neurons.

18. The system of claim 15, wherein training the respective layers of the plurality of layers is performed using a stochastic gradient descent technique.

19. The system of claim 15, wherein the stochastic gradient descent technique employs a loss functions comprising a differentiable regularization term which favors a lesser total number of auxiliary parameters in the network.

20. The system of claim 15, wherein the respective gating parameters are non-stochastic.
